(19) United States
(12) Patent Application Publication
(10) Pub. No.: US 2013/0101856 A1
(43) Pub. Date: Apr. 25, 2013

(54) WAFER BACKSIDE COATING CONTAINING REACTIVE SULFUR COMPOUND

(71) Applicant: Henkel Corporation, Rocky Hill, CT (US)

(72) Inventors: Sharad Hajela, San Carlos, CA (US); Shengqian Kong, Hillsborough, NJ (US); Jeffrey Gasa, Long Beach, CA (US); Jeffrey Leon, Long Beach, CA (US); Dung Nghi Phan, Long Beach, CA (US)

(73) Assignee: Henkel Corporation, Rocky Hill, CT (US)

(21) Appl. No.: 13/707,803

(22) Filed: Dec. 7, 2012

Related U.S. Application Data
(63) Continuation of application No. PCT/US2011/039061, filed on Jun. 3, 2011.
(60) Provisional application No. 61/352,594, filed on Jun. 8, 2010.

(51) Int. Cl. C09D 163/04

(52) U.S. Cl. CPC C09D 163/04
USPC 428/413; 522/8

(57) ABSTRACT

A wafer backside coating compositions comprises an epoxy, a resin with ethylenic unsaturation, and a reactive sulfur compound and is effective to reduce delamination during reflow operations.

### FIELD OF THE INVENTION

This invention relates to a coating for the inactive side (backside) of a semi-conductor wafer in which the coating contains a reactive sulfur compound.

### BACKGROUND OF THE INVENTION

Recent advancements in semiconductor packaging have led to the downsizing of the package through the use of thinner dies in a stacked arrangement (two or more semiconductor dies are mounted on top of one another). This stacking of dies enables increased functionality in a small footprint, allowing for downsizing of the overall semiconductor package. Typically, an adhesive paste or film is used between the two semiconductor dies to ensure package integrity during fabrication operations, such as, wirebonding, molding, and solder reflow, and during end use. However, the thinness of the dies makes them susceptible to warping and delamination in the solder reflow step of the fabrication process. The warping and delamination could be controlled with a paste or liquid wafer backside coating that can undergo the reflow process and maintain its integrity and functionality.

### SUMMARY OF THE INVENTION

This invention is a coating composition for the inactive side (backside) of a semiconductor wafer in which the coating comprises (i) an epoxy resin and, optionally, a curing agent for the epoxy resin, (ii) a resin containing ethylenic unsaturation and a photoinitiator for the resin, (iii) a reactive sulfur compound, and (iv) optionally, a non-conductive filler. In one embodiment, the reactive sulfur compound is a polymeric mercaptan-pendant silicone. In another embodiment this invention is a semiconductor wafer coated with a cured coating composition as above described.

### DETAILED DESCRIPTION OF THE INVENTION

As used herein, the term “B-staging” (and its variants) is used to refer to the processing of a material by heat or irradiation so that if the material is dissolved or dispersed in a solvent, the solvent is evaporated off with or without partial curing of the material, or if the material is neat with no solvent, the material is partially cured to a tacky or more hardened state. If the material is a flow-able adhesive, B-staging will provide extremely low flow without fully curing, such that additional curing may be performed after the adhesive is used to join one article to another. The reduction in flow may be accomplished by evaporation of a solvent, partial advancement or curing of a resin or polymer, or both.

As used herein the term “curing agent” is used to refer to any material or combination of materials that initiate, propagate, or accelerate cure of the composition and includes but is not limited to accelerators, catalysts, initiators, and hardeners.

The semiconductor wafer may be any type, size, or thickness as required for the specific industrial use.

Suitable epoxy resins for use in the coating composition are solid, and include those epoxies selected from the group consisting of cresol novolac epoxy, phenol novolac epoxy, bisphenol-A epoxy, and glycidylated resins containing backbones consisting of phenolic and fused rings systems (such as dicyclopentienyl groups). In one embodiment the epoxy resin is a solid with a melting point between 80° and 130° C. In another embodiment the epoxy resin is present in an amount of 15 to 40% by weight of the coating.

Suitable acrylate resins include those selected from the group consisting of butyl (meth)acrylate, isobutyl (meth)acrylate, 2-ethyl hexyl (meth)acrylate, isodecyl (meth)acrylate, n-lauryl (meth)acrylate, alkyl (meth)acrylate, tridecyl (meth)acrylate, n-stearyl (meth)acrylate, cyclohexyl(meth)acrylate, tetrahydrofurfuryl(meth)acrylate, 2-phenoxy ethyl(meth)acrylate, isobornyl(meth)acrylate, 1,4-butanediol di(meth)acrylate, 1.6 hexanediol di(meth)acrylate, 1,9-nonandiol di(meth)acrylate, perfluorooctylethyl (meth)acrylate, 1,10 decandiol di(meth)acrylate, nonylphenol polypropoxylate (meth)acrylate.

Other acrylate resins include polypentoxylate tetrahydrofurfuryl acrylate, available from Kyoeisha Chemical Co., LTD; polybutadiene urethane dimethacrylate (CN302, NTX6513) and polybutadiene dimethacrylate (CN301, NTX6039, PRO6270) available from Sartomer Company, Inc; polycarbonate urethane diacrylate (ArtResin UN9200A) available from Negami Chemical Industries Co., LTD; acrylated aliphatic urethane oligomers (Ebecryl 230, 264, 265, 270,284, 4830, 4833, 4834, 4835, 4866, 4881, 4883, 8402, 8800-20R, 8803, 8804) available from Radcure Specialities, Inc; polyester acrylate oligomers (Ebecryl 657, 770, 810, 830, 1657, 1810, 1830) available from Radcure Specialities, Inc.; and epoxy acrylate resins (CN104, 111, 112, 115, 116, 117, 118, 119, 120, 124, 136) available from Sartomer Company, Inc.

Further acrylate resins include monocyclic acetal acrylate, (meth)acrylates containing cyclic acetals (such as, SR531 available from Sartomer); THF acrylate (such as, SR285 available from Sartomer); substituted cyclohexy (meth)acrylates (such as, CD420 available from Sartomer); acetoacetoxyethyl methacrylate, 2-acetoacetoxyethyl acrylate, 2-acetoacetoxypropyl methacrylate, 2-acetoacetoxypropyl acrylate, 2-acetoacetamidoethyl methacrylate, and 2-acetoacetamidoethyl acrylate; 2-cyanoacetoxyethyl methacrylate, 2-cyanoacetoxyethyl acrylate, N(2-cycanoacetoxyethyl) acrylamide; 2-propionylacetoxyethyl acrylate, N(2-propionylacetoxyethyl) methacrylamide, N-4-(acetoacetoxybenzyl phenyl acrylamide, ethylacryloyl acetate, acryloylmethyl acetate, N-ethacryloyloxymethyl acetoacetamide, ethylmethacryloyl acetoacetate, N-allylcyanoacetamide, methylacryloyl acetoacetate, N(2-methacryloyloxymethyl) cyanoacetamide, ethyl-a-acetoacetoxy methacrylate, N-butyl-N-acryloyloxyethyl acetoacetamide, monoacrylated polyols, monomethacryloyloxyethyl phthalate, and mixtures thereof.

In one embodiment, the acrylate is chosen to have low viscosity (<50 mPas) and a boiling point greater than 150° C. In a particular embodiment, the low viscosity, high boiling acrylate contains a five- or six-membered ring containing at least one oxygen in the ring.

In one embodiment the acrylate resin comprises 15 to 50% by weight of the coating composition.

Suitable curing agents for the epoxy resin are present in an amount between greater than 0 and 50% by weight and include, but are not limited to, phenolics, aromatic diamines, dicyandiamides, peroxides, amines, imidizoles, tertiary amines, and polyamides. Suitable phenolics are commercially available from Schenectady International, Inc. Suitable aromatic diamines are primary diamines and include diaminodiphenyl sulfone and diaminodiphenyl methane, commercially available from Sigma-Aldrich Co. Suitable dicyandiamides are available from SKW Chemicals, Inc. Suitable polyamides are commercially available from Air Products and Chemicals, Inc. Suitable imidazoles are commercially available from Air Products and Chemicals, Inc. Suitable tertiary amines are available from Sigma-Aldrich Co.

Suitable curing agents for the resin with ethylenic unsaturation are present in an amount between 0.1 to 10% by weight and include, but are not limited to, any of the known acetophenone-based, thioxanthone-based, benzoin-based and peroxide-based photoinitiators. Examples include diethoxyacetophenone, 4-phenoxydichloroacetophenone, benzoin, benzoin ethyl ether, benzoin isopropyl ether, benzyl dimethyl ketal, benzophenone, 4-phenyl benzophenone, acrylated benzophenone, thioxanthone, 2-ethylanthraquinone, etc. The Irgacur and Darocur lines of photoinitiators sold by BASF are examples of useful photoinitiators.

Reactive sulfur compounds include thiols and dithioesters. In one embodiment, the reactive sulfur compounds are selected from the group consisting of dodecyl mercaptan, tertiary dodecyl mercaptan, mercaptoethanol, octyl mercaptan, hexyl mercaptan, isopropyl xanthic disulfide, and mercaptan-pendant silicone polymer. Reactive sulfur compounds will be present in the coating composition in an amount form 0.1 to 7% by weight.

In one embodiment, the reactive sulfur compound is a polymeric mercaptan-pendant siloxane. An example of a mercaptan-pendant siloxane polymer has the following structure

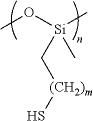

in which n denotes an integer between 5 and 500 denoting a polymeric number of repeating units, and m is an integer of 1 to 5. The polymeric mercaptan-pendant siloxane will be present in an amount from 0.1 to 7% by weight of the coating composition.

Fillers are optional. In some embodiments, nonconductive fillers are present. Examples of suitable nonconductive fillers include alumina, aluminum hydroxide, silica, vermiculite, mica, wollastonite, calcium carbonate, titania, sand, glass, barium sulfate, zirconium, carbon black, organic fillers, and organic polymers including but not limited to halogenated ethylene polymers, such as, tetrafluoroethylene, trifluoroethylene, vinylidene fluoride, vinyl fluoride, vinylidene chloride, and vinyl chloride.

In other embodiments, conductive fillers are present. Examples of suitable conductive fillers include carbon black, graphite, gold, silver, copper, platinum, palladium, nickel, aluminum, silicon carbide, boron nitride, diamond, and alumina. The particular type of filler is not critical and can be selected by one skilled in the art to suit the needs of the specific end use, such as stress reduction and bondline control.

Spacers may also be included in the formulation to control the bondline thickness of the bonded part, in types and amounts selected by the practitioner to meet the needs of the particular application.

Filler may be present in any amount determined by the practitioner to be suitable for the chosen resin system and end use and when present typically ranges between 10 and 30% by weight of the composition.

When present, preferably the fillers are spherical in shape with an average particle diameter of greater than 2 μm and a single peak particle size distribution. Smaller particle sizes and bimodal distributions result in an unacceptably high thixotropic index.

Other additives, including but not limited to adhesion promoters, antifoaming agents, antibleed agents, rheology control agents, and fluxing agents, in types and amounts known to those skilled in the art, may be included in the coating formulation. In a preferred embodiment, solvents are not used.

The coating can be any thickness required for the appropriate protection, bonding, or processing performance for the particular manufacturing use and would typically be between 12 μm and 60 μm. In one embodiment the coating thickness is 40 μm.

The coating is disposed onto the wafer by any effective means used in the industry, such as, for example, stencil printing, screen printing, spraying processes (ultrasonic, piezolelectric, pneumatic), jetting processes (such as through a thermal or piezoelectric (acoustical) head), or spin-coating. B-stage curing can be accomplished by actinic irradiation or heating.

In a preferred embodiment, the coating is B-staged by exposure to a pulsed UV light source at 180nm to 800nm, with a total irradiation exposure of 0.01-10 J/cm². A suitable pulsed UV light source is an Xenon lamp (Xenon Corp., Wilmington Mass.).

Example: Three adhesive compositions were formulated to contain the components shown in the following table. The glycidylated o-cresol formaldehyde novolac, having a softening point of 85° C. and an epoxy equivalent weight of 203, was mixed into tetrahydrofurfuryl acrylate at 80° C., and to this was added the remaining components of the compositions. No solvents were used in the compositions. The photoinitiator mixture consisted of 2,4,6-trimethylbenzoyl-diphenyl-phosphineoxide and 2-hydroxy-2-methyl-1-phenyl-propan-1-one. The mercaptan pendant silicone was a polymeric silicone with pendant mercaptan groups from Gilest Corp., having a molecular weight of 4000-7000. The fused silica was spherical particles dry sieved to 5 microns. The mixture was hand-mixed and passed four times through a three-roll ceramic mill.

| | FORMULA- | | FORMULA- | | FORMULA- | |
|---|---|---|---|---|---|---|
| ADHESIVE | TION A | | TION B | | TION C | |
| COMPO- | | Amount | | Amount | | Amount |
| SITIONS | % w/w | (g) | % w/w | (g) | % w/w | (g) |
| glycidylated | 38.00% | 30.40 | 37.91% | 30.32 | 37.81% | 30.25 |
| o-cresol | | | | | | |
| formaldehyde | | | | | | |
| novolac | | | | | | |
| tetrahydro- | 19.00% | 15.20 | 18.95% | 15.16 | 18.91% | 15.12 |
| furfuryl | | | | | | |
| acrylate | | | | | | |
| trimethylcyclo- | 19.00% | 15.20 | 18.95% | 15.16 | 18.91% | 15.12 |
| hexyl | | | | | | |
| acrylate | | | | | | |
| photoinitiator | 3.00% | 2.40 | 2.99% | 2.39 | 2.99% | 2.39 |
| mixture | | | | | | |
| 2-phenyl-4- | 1.00% | 0.80 | 1.00% | 0.80 | 1.00% | 0.80 |
| methyl- | | | | | | |
| imidazole | | | | | | |
| mercaptan- | 0.00% | 0.00 | 0.20% | 0.16 | 0.40% | 0.32 |
| pendant | | | | | | |
| silicone | | | | | | |
| fused silica | 20.00% | 16.00 | 20.00% | 16.00 | 20.00% | 16.00 |

Each of the three formulations were spin-coated (independently) to a thickness of 40 microns onto 9 mm×9 mm pre-diced 15 mil (thick) wafers. The spin profile used was: 350 RPM for 20 seconds, 1000 RPM for 30 seconds, then 300 RPM for 5 seconds. The wafers were adhered to a second non-diced wafer using dicing tape and the formulations cured by UV light (Fusion 558432HUSA UV lamp, Fusion UV System Inc.) at a total exposure of 1.7 J/cm².

The pre-cut dies were removed from the wafer and bonded onto smooth BT substrate using a Toray FC-100M thermal compression bonder (Toray Engineering Co. Ltd) operating with the following optimized bonding conditions for the formulations:

| | Stage temp | Head temp | Force | Time |
|---|---|---|---|---|
| Formulation | (° C.) | (° C.) | (N) | (sec) |
| A | 140 | 250 | 25 | 1 |
| B | 140 | 100 | 15 | 1 |
| C | 120 | 100 | 15 | 1 |

The substrate/die assemblies were cured in an oven at 150° C. for one hour with a 30 minute ramp. Scanning acoustic micrographs (SAMs) were taken using a Sonix UHR-2000 instrument (Sonix Inc.). The substrate/die assemblies were transferred to a humidity oven and were heated at 85° C. and 85% humidity for 24 hours. The substrate/die assemblies were then passed through a reflow oven at 260° C. three times. SAMs were taken again.

After the initial thermal cure, all three formulations showed perfect bonds, free of delamination and voiding. After the 85° C. and 85% humidity treatment for 24 hours and reflow oven, Formulation A with no thiol-containing silicone showed gross delamination in six out of six sample dies; Formulation B with 0.20% of the thiol containing silicone showed no failures in six out of six sample dies. Formulation C with 0.40% of the thiol containing silicone showed minor delamination in one out of six sample dies. The data show that the presence of a mercaptan is effective to counteract delamination.

What is claimed:

1. An adhesive composition comprising
(i) an epoxy resin,
(ii) a resin having ethylenic unsaturation and a photoinitiator; and
(iii) a reactive sulfur compound.

2. The adhesive composition according to claim 1 in which the epoxy resin is selected from the group consisting of cresol novolac epoxy, phenol novolac epoxy, and bisphenol-A epoxy.

3. The adhesive composition according to claim 2 in which the epoxy resin is present in an amount of 20 to 40% by weight of the coating.

4. The adhesive composition according to claim 1 in which the epoxy resin is a solid with a melting point between 80° and 130° C.

5. The adhesive composition according to claim 1 further comprising a curing agent for the epoxy resin.

6. The adhesive composition according to claim 1 in which the resin having ethylenic unsaturation is an acrylate resin.

7. The adhesive composition according to claim 6 in which the acrylate resin contains a five- or six-membered ring containing at least one oxygen in the ring and has a viscosity less than 50 mPas and a boiling point greater than 150° C.

8. The adhesive composition according to claim 1 in which the reactive sulfur compound is a polymeric mercaptan-pendant silicone having the structure 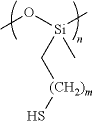
in which n is an integer between 5 and 500, and m is an integer of 1 to 5.

9. The adhesive composition according to claim 1 in which (i) the epoxy resin is a solid with a melting point between 80° and 130° C., (ii) the resin having ethylenic unsaturation is an acrylate resin having a viscosity less than 50 mPas and a boiling point greater than 150° C., and (iii) the reactive sulfur compound is a polymeric mercaptan-pendant silicone having the structure 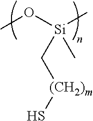
in which n is an integer between 5 and 500, and m is an integer of 1 to 5.

10. A semiconductor wafer coated with a cured coating composition in which the coating composition comprises (i) a solid epoxy resin with a melting point between 80° and 130° C.; (ii) an acrylate resin having a viscosity less than 50 mPas and a boiling point greater than 150° C.; and
(iii) a polymeric mercaptan-pendant silicone having the structure 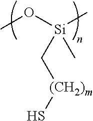
in which n is an integer between 5 and 500, and m is an integer of 1 to 5.
